(19) United States
(12) Patent Application Publication
(10) Pub. No.: US 2004/0030533 A1
(43) Pub. Date: Feb. 12, 2004

(54) Site monitoring method and site monitoring system

(76) Inventors: Shinji Hirose, Tokyo (JP); Makoto Tsychiya, Tokyo (JP)

Correspondence Address: GRIFFIN & SZIPL, PC, SUITE PH-1, 2300 NINTH STREET, SOUTH, ARLINGTON, VA, 22204, US

(21) Appl. No.: 10/433,882

(22) PCT Filed: Dec. 6, 2001
(86) PCT No.: PCT/JP01/10675

(30) Foreign Application Priority Data
Dec. 6, 2000 (JP) 2000/371001
Feb. 27, 2001 (JP) 2001/51493

(51) Int. Cl. G06F 11/00; G06F 15/00

(52) U.S. Cl. 702/188

(57) ABSTRACT

A monitor server 12 for monitoring a site used by Internet connection by a portable terminal and connected to the portable terminal through a portable packet network and a gateway is provided to adequately monitor the site. The monitor server 12 comprises an URL access activating processing section 54 for making an URL access to a site by controlling a portable terminal 16 through a portable packet network and a gateway at a predetermined timing, a service response monitoring processing section 56 and a service performance monitoring processing section 58 for obtaining response data that the portable terminal receives through the gateway and the portable packet network from the site, analyzing the response data, and detecting if any abnormality or trouble has occurred in the site, an alarm notification processing part 42 for generating alarm data for notifying of an abnormality or trouble, if occurred, and sending the data to another system.

### TECHNICAL FIELD OF THE INVENTION

The present invention is generally related to a monitoring system used in a network, which monitors servers and the like which may belong to any sites connected with Internet, and more particularly to a monitoring system which monitors sites which provide cellular phones and PDAs with content.

### BACKGROUND OF THE INVENTION

Internet connection services using portable terminals such as cellular phones and PDAs are now up and running, and a remarkable number of users make use of these services. Here, the data transmitted from the portable terminals may be transmitted to a telephone communication service carrier's gateway (GW) through a cellular packet network once, and thereafter, the data may be delivered to the private line or Internet from the gateway and reach the website. Naturally, the data from the website are transmitted to the portable terminals through the gateway and the cellular packet network.

Therefore, it differs from a typical connecting route to Internet (that is, the order of a personal computer-a public telephone network-an access point of a service provider-Internet).

On the other hand, as Internet connection services using cellular phones have spread explosively, the occurrence of line problems owing to the access concentration of a lot of users and invasions to the sites by hackers or the like have become serious problems. A system which monitors the site's operation state and the like using a monitor server connected to Internet has been proposed so as to monitor such abnormalities and problems. For instance, the applicant has developed a system for monitoring various sites on Internet which connects the monitor server to Internet in a manner as disclosed in PCT/JP01/06370.

However, there was a problem that it was not possible to know the access state from the actual portable terminal by monitoring from Internet because connected routes to the sites in Internet connection service using portable terminals differed from those in the usual Internet connection service. Especially, it may be impossible to monitor sites connected with the gateway through a private line if only Internet is used.

The object of the present invention is to provide a system which can appropriately monitor sites used by Internet connection services using portable terminals.

### SUMMARY OF THE INVENTION

The object of the present invention is accomplished by providing a method for monitoring a site connected through a cellular packet network and a gateway from a portable terminal, the method comprising, with a monitor server for causing the portable terminal to execute an access by use of a prescribed URL through the cellular packet network, a step for controlling the portable terminal to cause it to access the site by use of the URL at a prescribed timing through a route of the cellular packet network and the gateway, a step for obtaining response data received by the portable terminal from the site through the gateway and the cellular packet network, a step for detecting whether any abnormality or problem occurs on the site by analyzing the response data, and a step for generating notification data for notifying of the abnormality or problem when any abnormality or problem occurs and transmitting them to another system.

According to the present invention, the site is accessed through the portable packet network and the gateway, and abnormalities and problems are detected based on response to the access. Therefore, it is possible to monitor the site connected to the gateway through private lines, and to appropriately detect abnormalities and problems which occur as typical users access the site.

In the preferred aspect of the present invention, the method further comprises a step for examining a detail of the response data including an error and the like, and for measuring a response period.

Moreover, it is preferable that the step for detecting whether any abnormality or problem occurs further comprises a step for calculating a difference between the web content included in the response data at the last step for detecting and the web content included in the response data at this time, and a step for detecting, based on the difference, whether the content has not been subjected to an undesirable modification or whether the content has been appropriately updated.

In the preferred aspect, moreover, the method comprises a step for storing a sequence including commands to access web pages constituting the site along with a prescribed order according to a site map of the site to be monitored, and wherein the step for accessing by use of the prescribed URL is accomplished according to the commands in the sequence. As a result, it is possible to access the pages one by one according to the site map, to obtain response data in more detail, and to monitor the sites more appropriately.

It is preferable that the command includes an alphanumeric string to be inputted in the prescribed web page and the method further comprises a step for transmitting data corresponding to the character string to the site through the cellular packet network and the gateway by controlling the portable terminal to input the character string in the prescribed web page.

Moreover, in the preferred aspect, the method comprises a step for relating an emulation program, which corresponds to a terminal application to be downloaded with a terminal application specification tag in a web page constituting the site to be monitored, to the URL of the above web page, and storing the emulation program and the URL together with the relationship, a step for executing the emulation program after accessing by use of the URL stored together with the relationship, and a step for transmitting data showing a result of the execution of the emulation program to the site through the cellular packet network and the gateway by controlling the portable terminal. It is applicable for the step of executing the emulation program to include input of a prescribed alphanumeric string.

Moreover, the object of the present invention is also accomplished by providing a method for monitoring a site connected through a cellular packet network and a gateway from a portable terminal, the method comprising: a step for placing a plurality of monitor servers apart from each other to cause the portable terminal to execute an access by use of the prescribed URL through the cellular packet network; with one monitor server, a step for controlling the portable terminal to cause it to access the site by use of the URL at a prescribed timing, through a route of the cellular packet network and the gateway; a step for obtaining response data received by the portable terminal from the site through the gateway and the cellular packet network; a step for detecting whether any abnormality or problem occurs on the site by analyzing the response data; a step for generating notification data for notifying of the abnormality or the problem when any abnormality or problem occurs and transmitting them to a central system connected with the monitor server through a network; with the central system, in response to receipt of the notification data, a step for requesting one or more other monitor servers other than the monitor server in question to access the site by use of the URL; with the other monitor servers, a step for controlling the portable terminal to cause it to access the site by use of the URL at the prescribed timing through a route of the cellular packet network and the gateway; a step for obtaining response data received by the portable terminal from the site through the gateway and the cellular packet network; a step for generating other notification data for notifying of a state of the site by analyzing the response data and transmitting them to the central system; and with the central system, a step for analyzing the abnormality and the problem based on the notification data and the other notification data to generate data indicative of an analytical result.

According to the present invention, a problem which is influenced by congestion in one packet base station can be appropriately detected.

It is preferable that the method comprises, with the central system, a step for specifying a server as a main server which may access the site by use of a URL and one or more other servers as reserve servers which may access the site by use of a URL when any abnormality or problem occurs to the main server. Thus, the main server and the reserve server are allocated, so that it is possible to appropriately monitor the site without too great a load on the portable packet network.

The object of the present invention is accomplished by providing a method for monitoring a site connected through a cellular packet network and a gateway from a portable terminal, the method comprising: a step for placing a plurality of monitor servers apart form each other to cause the portable terminal to execute an access by use of a prescribed URL through the cellular packet network; with each of the monitor servers, a step for controlling the portable terminal to cause it to access the site by use of the URL at a prescribed timing through a route of the cellular packet network and the gateway; a step for obtaining response data received by the portable terminal from the site through the gateway and the cellular packet network; a step for generating notification data for notifying of a state of the site by analyzing the response data, and transmitting them to a central system; and, with the central system, a step for analyzing an abnormality or problem based on the notification data to generate data indicative of an analytical result.

According to the present invention, it is possible to obtain the response performance for the site, which is not influenced by the congestion of each packet base station.

Moreover, the object of the present invention is accomplished by providing a system for monitoring a site connected through a cellular packet network and a gateway from a portable terminal, the system comprising: a portable terminal control means for controlling the portable terminal to cause it to access the site by use of a URL at a prescribed timing through a route of the cellular packet network and the gateway; a response data analysis means for obtaining response data received by the portable terminal from the site through the gateway and the cellular packet network and for determining whether any abnormality or problem occurs on the site by analyzing the response data; and a data communication means for generating notification data for notifying of the abnormality or problem when any abnormality or problem occurs and for transmitting them to another system.

In the preferred aspect, the system further comprises a storing means for storing a sequence including commands to access the web pages constituting the site along with a prescribed order according to a site map of the site to be monitored and/or an emulation program corresponding to a terminal application to be downloaded with a terminal application specification tag in the web page constituting the site together with the relationship thereof with the URL of the above web page, and wherein the portable terminal control means controls the portable terminal such that the URL access according to the commands in the sequence is executed, and/or when the URL access which is related to the emulation program is executed, the portable terminal executes the emulation program, so as to transmit data indicative of the result of the execution to the site.

In another aspect of the present invention, a system for monitoring a site connected through a cellular packet network and a gateway from a portable terminal comprises a plurality of monitor servers to cause the portable terminal to execute an access by use of a prescribed URL through the cellular packet network; and a central monitoring center system connected to the monitor servers through a network, wherein each of the monitor servers comprises a portable terminal control means for controlling the portable terminal to cause it to access the site by use of the URL at a prescribed timing through a route of the cellular packet network and the gateway; a response data analysis means for obtaining response data received by the portable terminal from the site through the gateway and the cellular packet network and for generating analytical data including the notification data indicative of occurrence of any abnormality or trouble on the site by analyzing the response data, and the central monitoring center system comprises a monitor server administration means for administering the monitor servers such that the monitor server administration means requests the prescribed monitor server to monitor one site as a main server and requests one or more monitor servers among the other monitor servers to monitor as reserve servers; and an abnormality analysis means for analyzing the abnormality or the trouble based on the notification data from the main server and the analytical data from the reserve servers and for generating data indicative of an analytical result.

In a still further aspect of the present invention, a system for monitoring a site connected through a cellular packet network and a gateway from a portable terminal comprises: a plurality of monitor servers to cause the portable terminal to execute an access by use of a prescribed URL through the cellular packet network; and a central monitoring center system connected to the monitor servers through a network; each of the monitor servers comprising; a portable terminal control means for controlling the portable terminal to cause it to access the site by use of the URL at a prescribed timing through a route of the cellular packet network and the gateway; a response data analysis means for obtaining the response data received by the portable terminal from the site through the gateway and the cellular packet network and for generating analytical data including notification data indicative of occurrence of any abnormality or problem on the site by analyzing the response data; and a data communication means for transmitting the notification data to the central system; and the central monitoring center system comprising; a monitor server administration means for administering the monitor servers to request the prescribed monitor servers among the monitor servers to monitor one site; and a route/site situation analysis means for receiving the analytical data about the one site obtained by each of the monitor servers and for generating data indicative of an analytical result about the route and the situation of the site.

In the above system, furthermore, the central system or the monitor server comprises: a storing means for storing a sequence including commands to access the web pages constituting the site along with a prescribed order according to a site map of the site to be monitored and/or an emulation program corresponding to a terminal application to be downloaded with a terminal application specification tag in the web page constituting the site together with the relationship thereof with the URL of the above web page, and wherein the portable terminal control means controls the portable terminal such that the URL access according to the commands in the sequence is executed, and/or when the URL access which is related to the emulation program is executed the portable terminal executes the emulation program, so as to transmit data indicative of the result of the execution to the site.

### BRIEF DESCRIPTION OF THE DRAWINGS

FIG. 1 is a block diagram showing a structure of a data communication system relating to a first embodiment of the present invention.

FIG. 2 is a block diagram showing a structure of a monitor server relating to the embodiment of the present invention in more detail.

FIG. 3 shows an example of data stored in a monitoring control DB relating to the embodiment of the present invention.

FIG. 4 is a flowchart showing a procedure executed in a monitoring process relating to the embodiment of the present invention.

FIG. 5 is a flowchart showing a procedure executed in the monitoring process relating to the embodiment of the present invention.

FIG. 6 is a block diagram showing a structure of a data communication system relating to a second embodiment of the present invention.

FIG. 7 is a block diagram showing the structure of a central monitoring center system relating to the second embodiment.

FIG. 8 shows an example of data stored in a site information DB 76 relating to the second embodiment.

FIG. 9 is a flowchart showing a monitoring procedure of a site in a normal monitoring mode relating to the second embodiment.

FIG. 10 is a flowchart showing an abnormal analytical process in the central monitoring center relating to the second embodiment.

FIG. 11 is a flowchart showing a processing procedure in an information gathering mode relating to the second embodiment.

FIG. 12 is a flowchart showing an analytical process in the central monitoring center in the information gathering mode relating to the second embodiment.

FIG. 13 is a block diagram showing the structure of a monitor server relating to a third embodiment.

FIG. 14 shows an example of data stored in a monitoring control DB relating to the third embodiment.

FIG. 15 is a flowchart showing an example of a process executed in a monitoring process relating to the third embodiment.

FIG. 16A shows a typical example of a sequence relating to the third embodiment, and FIG. 16B shows a typical example of an access based on the sequence.

FIG. 17 is a flowchart showing another example of a process executed in the monitoring process relating to the third embodiment.

### DESCRIPTION OF THE PREFERRED EMBODIMENTS

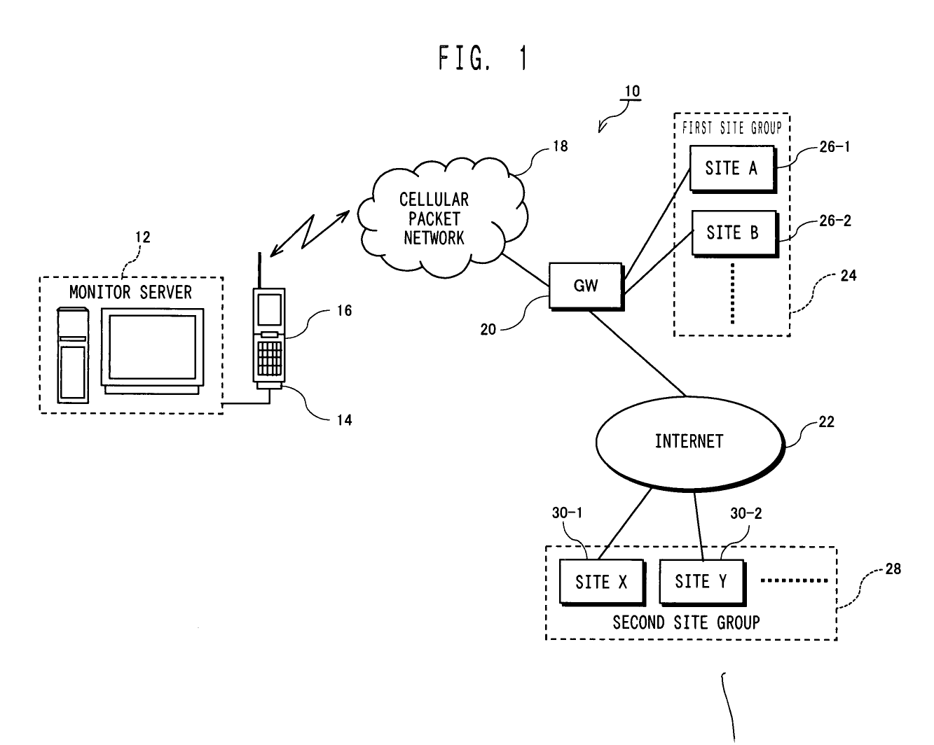

A first embodiment of the present invention will now be explained referring to the attached drawings. FIG. 1 is a block diagram showing a structure of a data communication system relating to the first embodiment of the present invention. As shown in FIG. 1, the data communication system 10 relating to the first embodiment comprises a monitor server 12, a portable terminal interface (I/F) 14 connected to the monitor server 12, and a portable terminal 16 connected to the portable terminal interface 14.

The signal from the portable terminal 16 is transmitted to the gateway (GW) 20 through a cellular packet network 18 along with the route of Internet connection service used by the portable terminals. The gateway 20 can connect with various sites 26-1, 26-2, . . . included in the first site group 24 through the private lines, and also connect with various sites 30-1, 30-2, . . . included in the second site group 28 through Internet 22.

In the present description, one or more servers may be connected with one site. It is not limited to one server corresponding to one content provider, and for instance, two or more content providers may exist in one server. On the other hand, one content provider may be using two or more servers. In the present description, the site means an area which has one or more servers which are partitioned from a global IP area by a firewall and the like, and are connect together through a local IP area.

Moreover, the first site group 24 actually means, in Internet connection service used by the portable terminal 16, a group of sites connected with the gateway through private lines without passing through Internet 22. For instance, the official site of the telephone carrier belongs to the first site group 24.

The portable terminal I/F 14 is shaped so as to be capable of attachment to the connector of the portable terminal 16. It can transmit a control signal necessary to operate the portable terminal 16 to the portable terminal 16 through the connector according to the data and instructions from the monitor server 12, and also has a function to receive the signal that the portable terminal 16 received through the connector and transmit the signal to the monitor server 12.

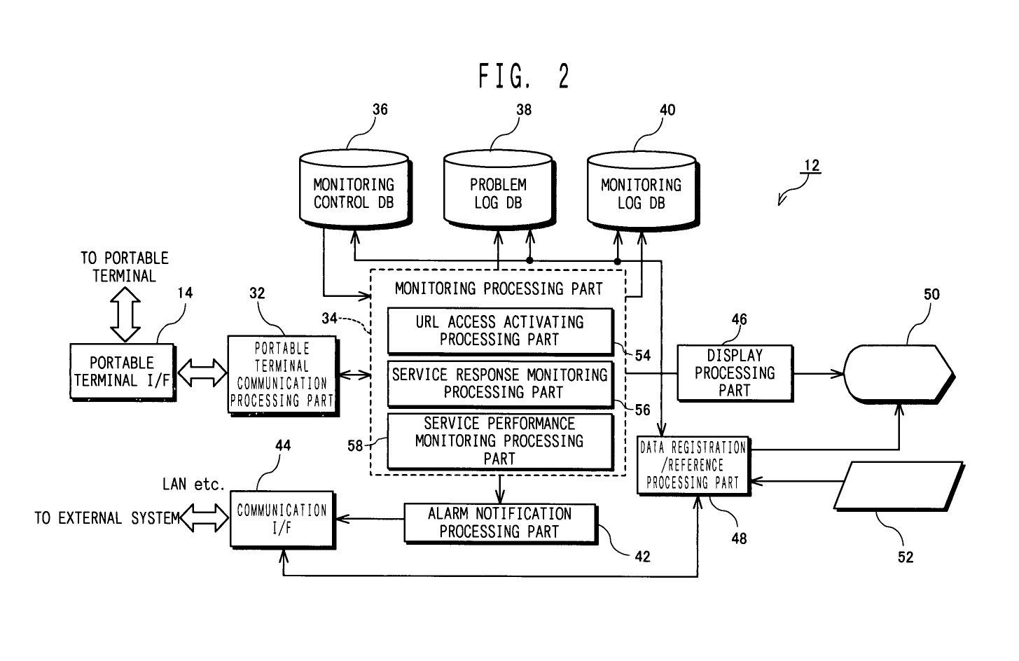

FIG. 2 is a block diagram showing the structure of the monitor server 12 related to the embodiments of the present invention in more detail. As shown in FIG. 2, the monitor server 12 comprises a portable terminal communication processing part 32 connected with the portable terminal I/F 14 to execute data transfer between the monitor server 12 and the communication processing part 32, a monitoring processing part 34 which is activated at the timing for monitoring the subject to be monitored to transmit necessary data through the portable terminal communication processing part 32, and to execute necessary processing based on the received data, a monitoring control database (DB) 36 which stores the URL, the monitoring content, the monitoring timing and the like of the sites to be monitored, a problem log DB 38 which stores problems of each monitored subject, a monitoring log DB 40 which stores the results of monitoring each monitored subject, an alarm notification processing part 42 which generates a necessary alarm when a problem occurs, a communication I/F 44 connected with LAN and the like to control the delivering/receiving the data to/from an external system (not shown) to which the alarm should be notified, a display processing part 46 which generates the images based on the results of the monitoring processing and the like, a data registration/reference processing part 48 which controls the data registration/readout and the like to/from the various DB 38-40, a display device 50 such as a CRT, and an input device 52 such as a keyboard, a mouse and the like.

In this monitor server 12, the monitoring processing part 34 refers to the monitoring control DB 36, and when it becomes the time to monitor a certain site, the monitoring processing part 34 activates the portable terminal 16 through the portable terminal I/F 14. The monitor server 12 then causes the portable terminal 16 to transmit the data necessary for the site to the site through the signal propagation route comprising the cellular packet network 18 and the gateway 20. Next, the monitor server 12 receives the response data from the site to be monitored through the gateway 20, the cellular packet network 18, the portable terminal 16 and the portable terminal I/F 14 in reverse order. Then the monitor server 12 detects the problems and abnormalities of the site based on the received response data.

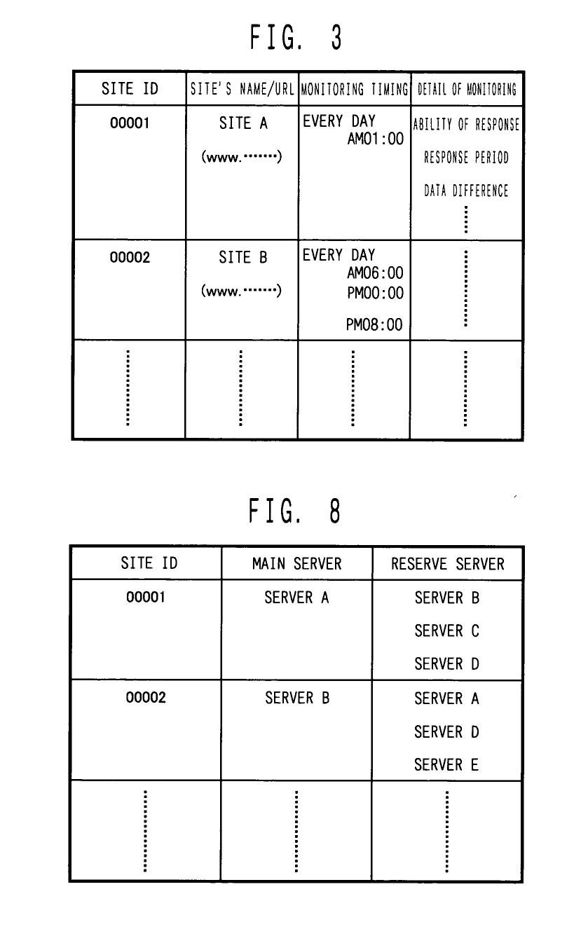

FIG. 3 shows an example of data stored in the monitoring control DB 36. As shown in FIG. 3, the monitoring control DB 36 stores the name, URL, monitoring timing and detail of monitoring of each site to be monitored in association with an ID given so that each site may be uniquely specified. In the present embodiment, the one or more can be selected optionally as the detail of the monitoring content from among the following items,

(1) Ability of response,

(2) Response period,

(3) Data difference,

(4) Check on the detail of the content,

(5) Response check on service ports other than Web,

and the like.

For instance, the ability of response is accomplished by determining whether the content is received, in response to the URL of the site transmitted through the portable terminal 16, the cellular packet network 18 and the gateway 20, or whether content is received with any errors.

For instance, the response period corresponds to the time period from the transmission of the data to the completion of the download of the content. Moreover, the data difference corresponds to the difference between the content downloaded last time and the content downloaded this time. Thus, the modification of data or the like by hackers and the like can be detected. Alternatively, it is possible to determine whether the content has been appropriately updated if the data had intended to be updated. In the check on the detail of content, the presence of a banner advertisement may be determined, for instance.

The site administrator specifies the monitoring timing and the detail of monitoring, when they request the monitoring of their own site or the telephone carrier requests the monitoring of the communication network through the cellular packet network 18 and the gateway 20.

More specifically, the administrator or the like operates the client machine or the like to transmit the monitoring request of the sites to an external system (not shown) which relates to the monitor server 12. The external system gives a site ID and transmits the data including the URL, the monitoring timing, and the detail of monitoring and the like to the communication I/F 44 in the monitor server 12 through a LAN or the like

When the data registration/reference processing part 48 receives the above-mentioned data through the communication I/F 44, it causes the received data to be correlated to the site ID and stores the data in the monitoring control DB 36. Thus, the site may be monitored using the portable terminal 16.

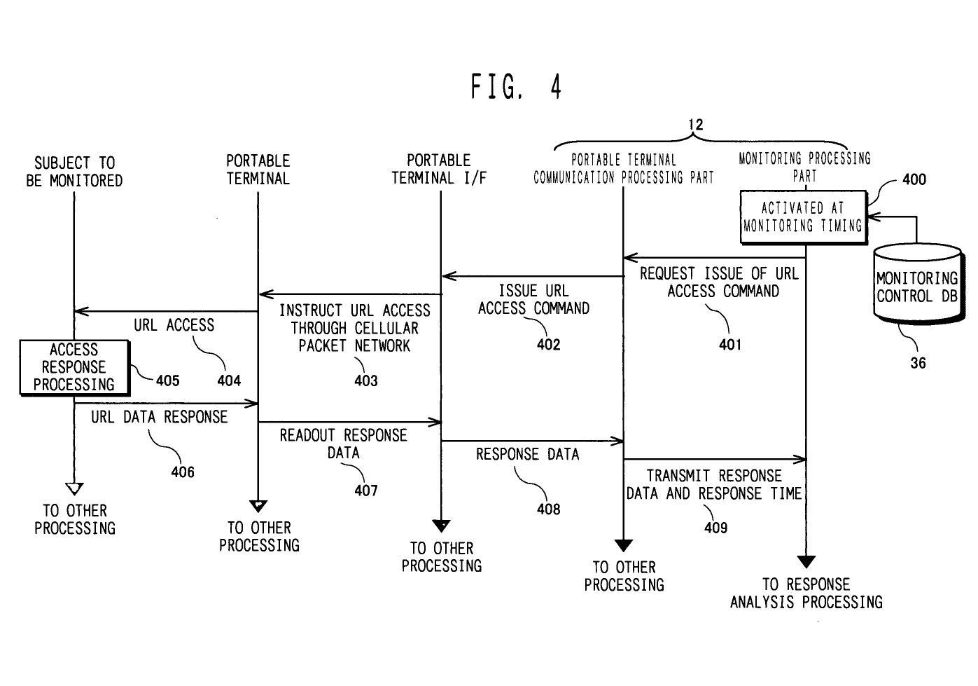

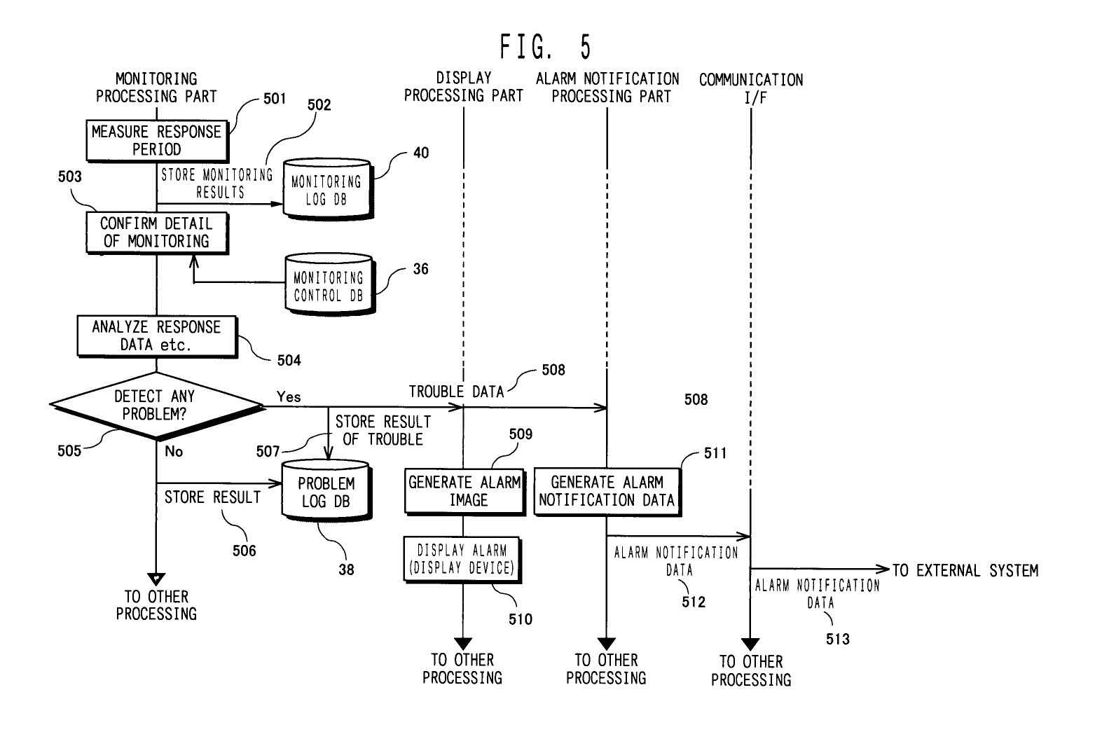

The monitoring processing with the thus constituted monitor server 12 will now be explained. FIG. 4 and FIG. 5 are flowcharts showing procedures executed in the monitoring processing. As shown in FIG. 4, a URL access activating processing part 54 in the monitoring processing part 34 refers to the monitoring control DB 34 to determine whether it is time to monitor the site (step 400). If it is time to monitor a certain site, the URL access activating processing part 54 extracts the URL of the site from the monitoring control DB 36 and transmits the issue request for the URL access command to the portable terminal communication processing part 32 to access the URL (step 401).

The portable terminal communication processing part 32 issues the URL access command to the portable terminal I/F 14 in response to the request for issue (step 402). In response thereto, the portable terminal I/F 14 transmits the access instruction along with the URL to the portable terminal 16 to cause it to access the prescribed site through the cellular packet network 18 and the GW 20 (step 403). As a result, the portable terminal 16 is activated and accesses the site specified by the URL through the route of the cellular packet network 18 and the GW 20 (step 404).

In the site to be monitored, the processing (for instance, making content and readouts from DB) responding to the access is executed (step 405), and the responding data (response data and content for instance) are sent back to the portable terminal 16 through the GW 20 and the cellular packet network 18 (step 406).

The portable terminal I/F 14 reads out the response data from the portable terminal 16, and forwards them to the portable terminal communication processing part 32 in the monitor server 12 (step 408). The portable terminal communication processing part 32 transmits the response data to the monitoring processing part 34 along with a URL transmission time and a response time (step 409).

When the monitoring processing 34 receives the response data, a service response monitoring processing part 56 and a service performance monitoring processing part 58 execute the response analysis processing. More specifically, the service performance monitoring processing part 58 measures the response period (step 501) based on the URL transmission time and the response period, and causes the response period to be correlated to the ID of the site to be monitored so as to store the response period in the monitoring log DB 40 (step 502).

Moreover, after the ID of the site to be monitored is referred to and detail of the monitoring is confirmed (step 503), the response data and the response period are analyzed according to the detail of the monitoring (step 504). For instance, the service response monitoring processing part 56 determines whether prescribed content was transmitted from the site to the portable terminal 16 in response to accessing the URL. Besides, the service response monitoring processing part 56 examines whether there was any response from the service ports other than the WEB.

Moreover, the service performance monitoring processing part 58 refers to the response period so as to determine whether the time period required for the access is abnormal. Furthermore, the service response monitoring processing part 58, according to the detail of monitoring, reads out from the monitoring log DB 40 the response data stored at the last monitoring and obtains a difference with this response data so as to determine whether an abnormal change is added to the content, whether the content has been updated appropriately, and/or whether necessary information for the content (for instance, banner advertising) is set up.

When no problem is detected as a result of judgment by the service response monitoring processing part 56 and the service performance monitoring processing part 58 (“No” at step 505), the analytical result of the response data and the like is stored in the problem log DB 38 (step 506).

On the other hand, when any abnormality or problem is detected (“Yes” at step 505), the analytical result indicative of the abnormality or problem is stored in the problem log DB 38 (step 507), and the data indicative of the abnormality or problem (problem data) is transmitted to the display processing part 46 and the alarm notification processing part 42 (step 508).

When the problem data are received the display processing part 46 generates the alarm image for notifying the operator of the occurrence of the site's problem (step 509) and outputs this to the display device 50, whereby the alarm image is displayed and it is possible to notify the operator of the occurrence of the abnormality or problem.

Moreover, when the alarm notification processing part 42 receives the problem data, it generates the alarm notification data for notifying the external system (for instance, system in the central monitoring center which controls the monitor server 12) of the problem (step 511). The generated alarm notification data are transmitted to the communication I/F 44 (step 512), and, in turn, transmitted from the communication I/F 44 to the above-mentioned external system through the LAN and the like.

As a result, the external system in a central monitoring center or the like can notify the site administrator's client machines, the portable terminal or the telephone communication service carrier's system.

As mentioned above, according to this embodiment, the monitor server accesses the site through the portable terminal, the public packet network and the GW and receives the response data so as to detect abnormalities and problems by analyzing the response data. Therefore, it is possible to monitor various sites in Internet connection service using the portable terminals where connected routes are different from the typical Internet. In particular, the monitoring of the sites 26-1, 26-2, . . . included in the first site group 24 connected to the GW 20 through the private lines becomes possible, for which the abnormalities and problems could not be detected by the conventional monitoring.

Moreover, a more detailed monitoring of the sites 30-1, 30-2, . . . included in the second site group becomes possible by combining with the technology which was described in PCT application (PCT/JP01/06370) previously filed by the present applicant.

Next, a second embodiment of the present invention will be explained. In the first embodiment, a single monitor server 12 monitors certain sites. That is, it can be assumed that the relationship of the monitor server 12 to the sites is one to many. On the other hand, in the second embodiment, a plurality of monitor servers placed at different positions monitor a certain site. That is, it can be assumed that the relationship of monitor servers to the sites is many to many.

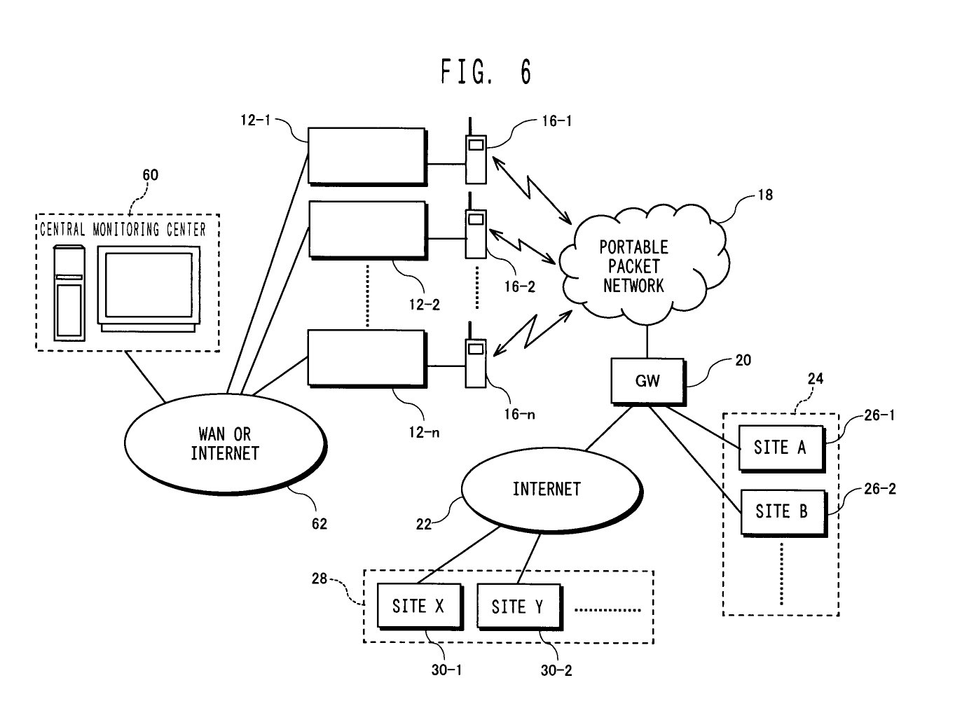

FIG. 6 is a block diagram showing a structure of a data communication system related to the second embodiment of the present invention. As shown in FIG. 6, two or more monitor servers 12-1, 12-2, . . . and a system 60 in a central monitoring center are connected with each other through a network 62 such as a WAN and Internet. The structure of each monitor server 12 is similar to the one in the first embodiment excluding some parts.

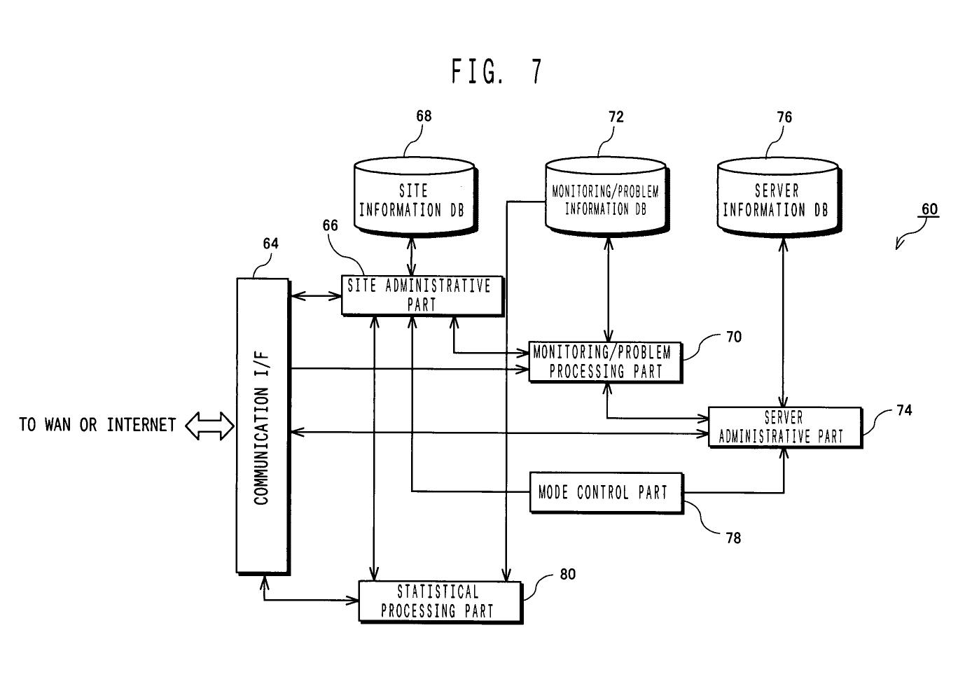

FIG. 7 is a block diagram showing a structure of the system 60 in the central monitoring center concerned with the second embodiment. As shown in FIG. 7, the system 60 in the central monitoring center comprises a communication I/F 64 which controls the delivering and receiving data using a network 62 such as the WAN and Internet etc., a site administrative part 66 which administers the data relating to the sites which should be administered, a site information DB 68 which stores various data concerning the sites, a response/problem processing part 70 which executes the prescribed processing in response to the data indicative of the notification, abnormality and problem from the monitor server 12, a monitoring/problem information DB 72 which stores the data supplied from the monitor server 12, a server administrative part 74 which administers each monitor server 12, a server information DB 76 which stores various information concerning the monitor servers 12, a mode control part 78 which controls monitoring modes and a statistical processing part 80 which executes statistical processing based on a monitoring situation if necessary. The structure from the monitor servers 12 to the portable terminal I/F 14 (not shown in FIG. 7), the portable terminal 16, the cellular packet network 18 and the GW 20 is similar to those in the first embodiment. Accordingly, the access route is similar to the one in the first embodiment. Here, it is preferable that the monitor servers 12 are arranged spaced apart from each other and the routes of the cellular packet networks 18 to the GW 20 are mutually different.

In this embodiment, the system operates under a normal monitoring mode to execute a normal site monitoring and an information gathering mode to generate statistical information which should be notified to the server administrator and the telephone communication service carrier. The switching of modes is accomplished by operation of the mode selection part 78 which gives an instruction to the site administrative part 66 and the server administrative part 74.

In the site information DB 68, data similar to the data in the monitoring control DB 36 (see FIG. 3) in the monitor server 12 related to the first embodiment are stored. Moreover, in the site information DB 76, for each site, the servers which should monitor the site are described as shown in FIG. 8. Here, a single main server and the two or more reserve servers in charge of a certain site are determined in this embodiment. The monitor server which becomes the main server executes the site monitoring at the monitoring timing in the normal monitoring mode. On the other hand, monitor servers which become the reserve servers are activated if any abnormality or problem occurs as a result of the monitoring by the main server so as to access the site.

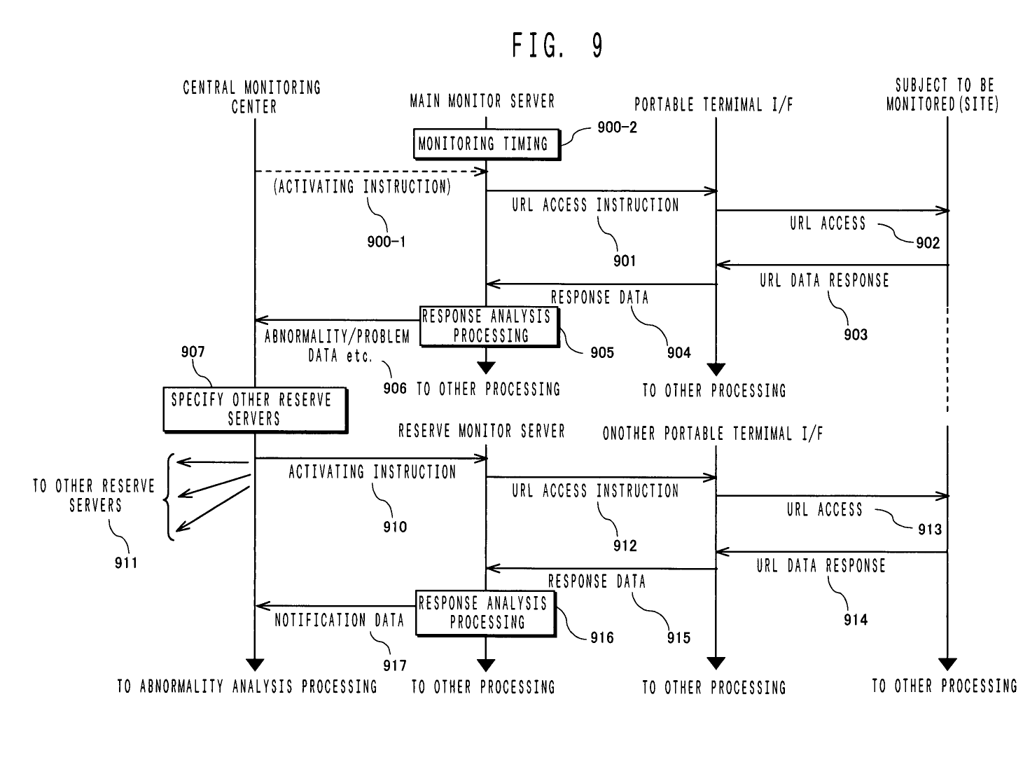

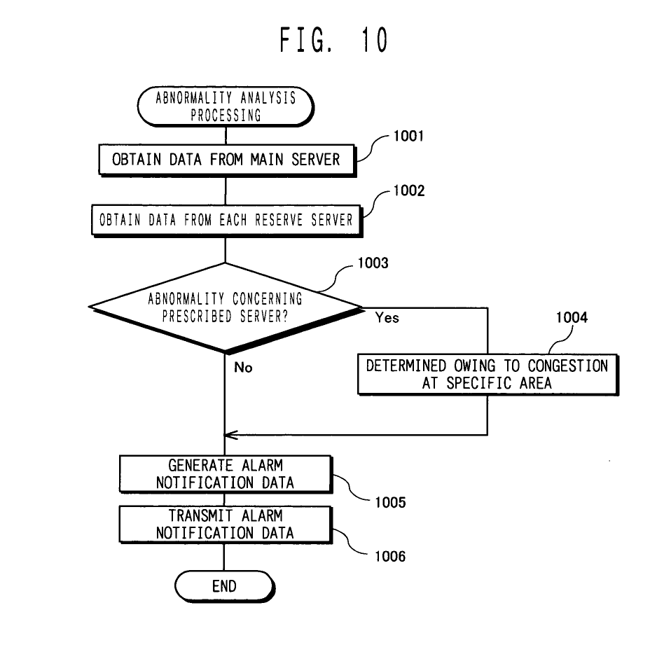

FIG. 9 is a flowchart showing a monitoring procedure of the site in the normal monitoring mode. The monitoring processing part 34 in the main monitor server 12 is activated by detecting the activating instruction from the system 60 in a central monitoring center (step 900-1) or the arrival of the monitoring timing (step 900-2), and accesses the site which is the subject to be monitored. The processing of the following steps 901-904 corresponds to that of steps 401-409 shown in FIG. 4.

After such processing, the response analysis processing is executed in the main monitor server 12 (step 905). This processing is also almost the same as the processing in steps 501-508 in FIG. 5.

When the main monitor server 12 determines that an abnormality or problem occurs on the site and the data which show the occurrence of such an abnormality of problem are transmitted to the system 60 in the central monitoring center (step 906), the response problem processing part 70 requests the server administrative part 74 to obtain the information concerning the reserve servers. As a result, the response problem processing part 70 can specify the reserve servers (step 907). Therefore, the activating instruction is transmitted from the communication I/F in the system 60 to the monitor servers which become the reserve monitor servers (step 910, 911).

The monitor servers as the reserve monitor servers which receive the activating instruction access the site to be monitored through the portable terminals and so on. The processing of steps 912-915 is also similar to the processing of steps 401-409 in FIG. 4. The monitor server which receives the response data analyzes the data (step 916) and transmits the analytical result (the detail of response (for instance, presence of the response), the response period and the like) to the system 60 (step 917).

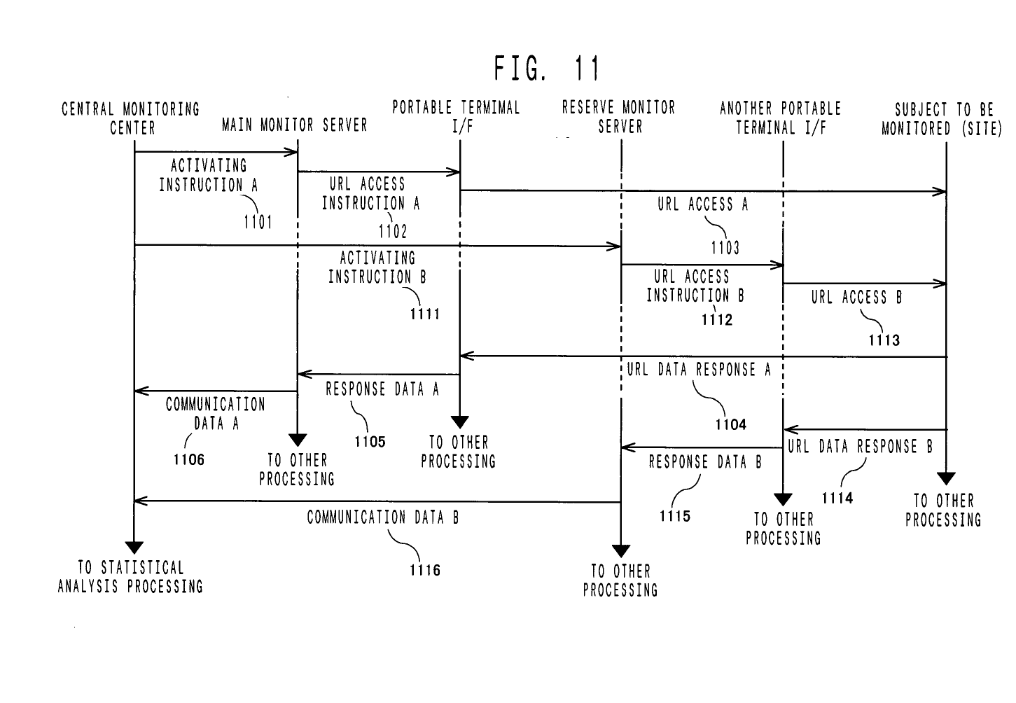

The system 60 analyzes what kind of abnormalities and problems have occurred based on the data received from the main server and the reserve servers. FIG. 10 is a flowchart showing the abnormal analytical processing in the central monitoring center 60. As shown in FIG. 10, after the data from the main server and the reserve servers are obtained (step 1001, step 1002), it is determined whether the data are related to the specific monitor server especially in consideration of the presence of the response and response period (step 1003). For instance, if they correspond to cases such that the response from just the main server is not obtained, and that the response periods from the main server and the reverse servers being adjacent thereto are remarkably long in comparison with those of others.

In the above cases (“yes” in step 1003), it can be determined that abnormalities and problems occur owing to congestion in a specific area. The notification of the alarm addressing for the server's administrator and the telephone communication service carrier is generated after such determination (step 1005), and then the notification is transmitted (step 1006).

Thus, according to the second embodiment, the servers are allocated to the main server and the reserve servers, and even if any abnormality or problem occurs in the main server, the reserve servers can access the sites. Accordingly, for instance, even if a problem in a specific area of the cellular packet exchanging network and the like occurs, it can be detected.

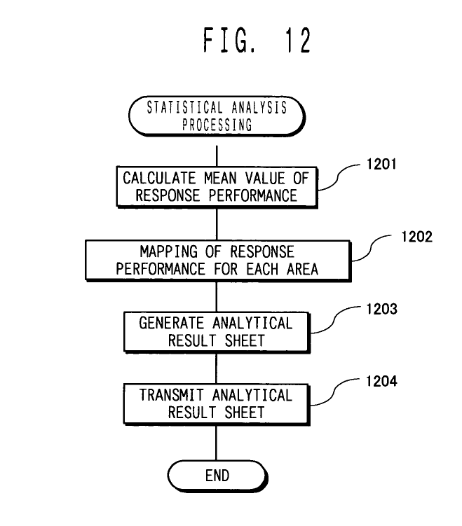

Next, the information gathering mode will now be briefly explained. FIG. 11 is a flowchart showing a processing procedure in the information gathering mode. In the information gathering mode, the system 60 in the central monitoring center instructs each of the main server and the reserve servers to be activated (steps 1101, 1111). Each monitor server, in response thereto, accesses the site to be monitored so as to collect the response data (steps 1102-1105, 1112-1115). Each monitor server generates the data (notification data A and notification data B) which should be notified to the system 60 in the central monitoring center based on the thus collected data (steps 1106, 1116), and transmits them to the system 60.

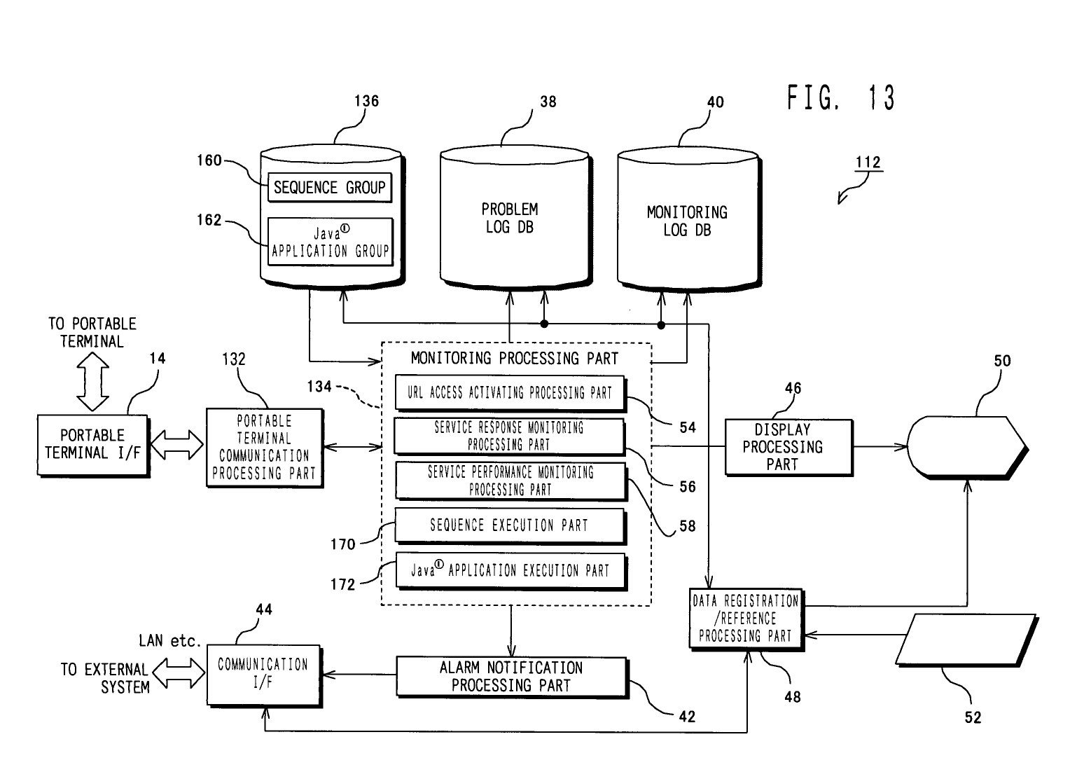

As shown in FIG. 12, the statistical processing part 80 in the system 60, for instance, calculates the mean value of the response period (step 1201), executes mapping of the response performance for each area (step 1202) and the like, based on the obtained data, and generates a sheet indicative of the analytical result (step 1203). The obtained sheet is transmitted to the site's administrator and the telephone communication service carrier through the communication I/F 64 (step 1204).

For instance, the calculation of the mean value of the response period makes it possible to obtain the guide of the site's response which is not influenced by the congestion of each packet base station. Also, the mapping of the response efficiency in each area can be used as material for the necessity of establishing more packet base stations.

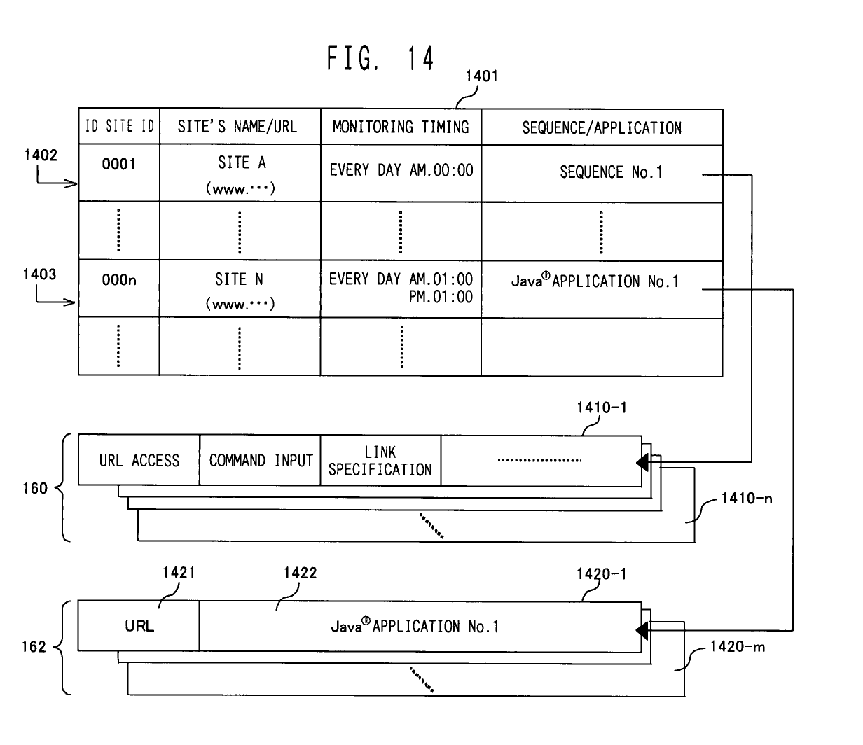

Next, a third embodiment of the present invention will be explained. In the third embodiment, the sequence corresponding to the user's operation and the like is prepared in advance, and according thereto, the access to the site is executed so as to receive the response from the site so that monitoring in the mode approximating real operation is accomplished. The structure of the data communication system relating to the third embodiment is similar to the one in the first embodiment shown in FIG. 1. As shown in FIG. 13, a monitor server 112 comprises a portable terminal communication processing part 132, a monitoring processing part 134, a monitoring control DB 136, the problem log DB 38, the monitoring log DB 40, the alarm notification processing part 42, the communication I/F 44, the display processing part 46, the data registration/reference processing part 48, the display device 50 and the input device 52.

The monitoring control DB 136 stores a sequence group 160, which is a set of sequences constituting a series of access commands and the like, and a Java (Registered Trademark, referred to as “TM” hereinafter) application group 162, which is a set of Java™ applications.

The monitoring processing part 134 comprises the URL access processing part 54, the service response monitoring processing part 56, and the service performance monitoring processing part 58, which are also included in the first embodiment, as well as a sequence execution part 170 which extracts the necessary sequence from the sequence group 160 and analyzes this so as to give a necessary instruction to the URL access processing part 54 and the like, and a Java™ application execution part 172 which extracts the prescribed Java™ application from the Java™ application group 162, and analyzes this so as to give a necessary instruction to the URL access processing part 54 and the like. These sequences and Java™ applications are stored in the monitoring control DB 136 in advance based on the site map and the access procedure of the site to be monitored, and based on applets downloaded by use of applet tags of the content delivered from the site (web page inside).

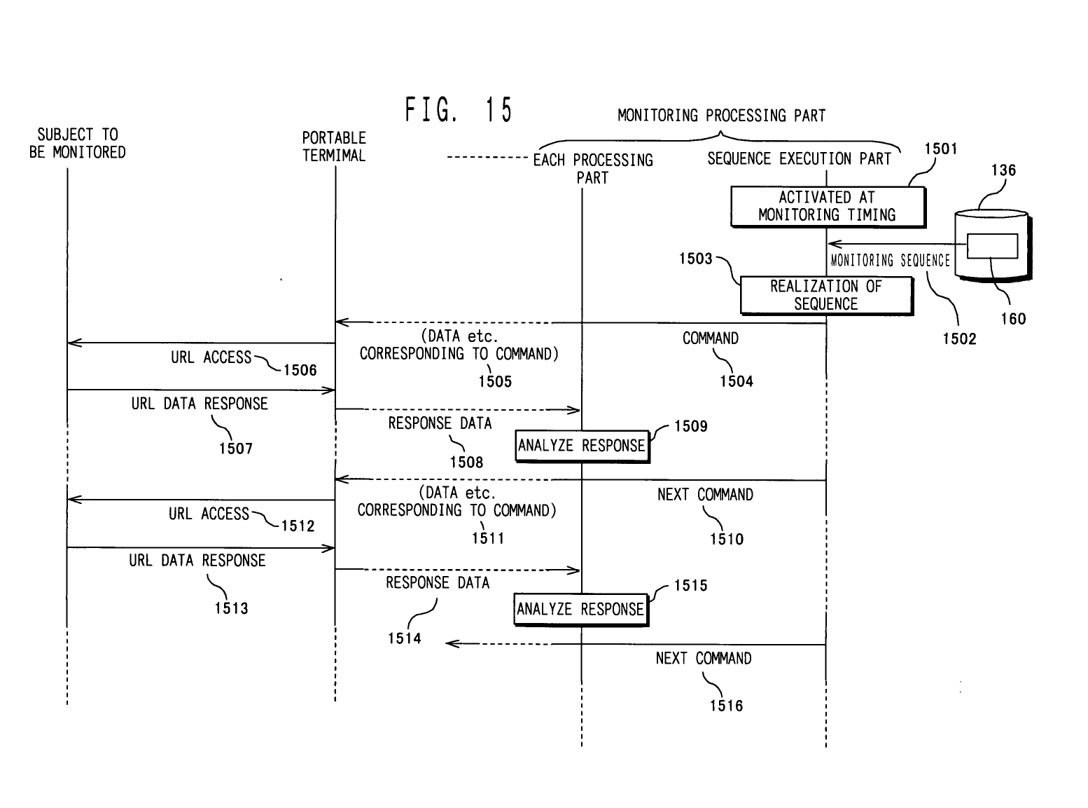

FIG. 14 shows an example of the data stored in the monitoring control DB 136. As shown in FIG. 14, a table 1401 comprises the name and URL of the site, the monitoring timing, and the pointer indicative of the sequence and the Java™ application to be followed when monitoring. By using the pointer, for instance, the sequence 1410-1 in the sequence group 160 is specified with respect to the site having site ID “0001” (See the numeral 1402) and the Java™ application 1420-1 in the Java™ application group 162 is specified with respect to the site having site ID “000n” (See the numeral 1403). The Java™ application 1420-1 includes the URL (numeral 1421) to access the necessary page such as the top page of the site, and the character string and the command input by the user when they execute the Java™ applications shown in FIG. 14.

The sequence describes the procedure for accessing the web page on the site by the route determined based on the site map such as the URL to be accessed, the command to be inputted, and the link specification.

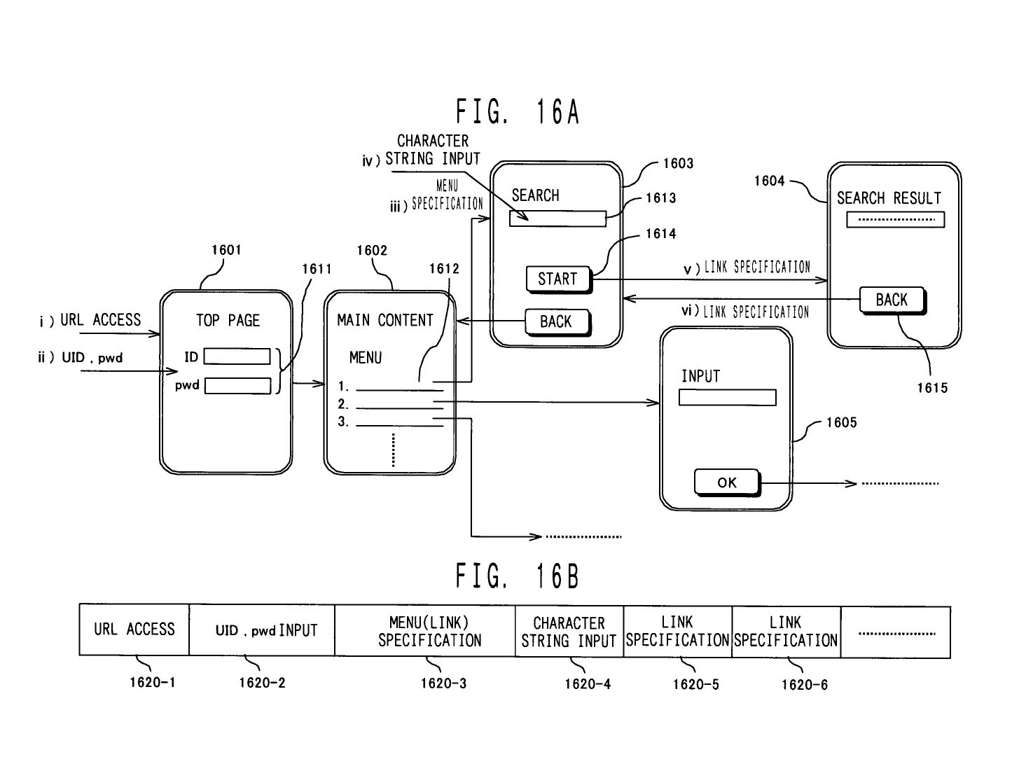

The monitoring processing with the thus structured monitoring server 112 will now be explained. FIG. 15 is a flowchart showing an example of a process executed in a monitoring process related to the third embodiment. The URL access activating processing part 54 in the monitoring processing part 34 refers to the monitoring control DB 136 to determine whether it is time to monitor the site. If the monitoring time for a certain site has arrived, the URL access activating processing part 54 activates the sequence execution part 170 or the JAVA™ application execution part 172. The sequence execution part 170 is activated as shown in the example shown in FIG. 15.

The sequence execution part 170 refers to tables in the monitoring DB 136 to obtain the sequence specified by the pointer. In FIG. 15, the sequence (monitor sequence) specified by the pointer is read out by the sequence execution part 170 (step 1502) and the detail thereof is realized (step 1503). The sequence execution part 170 issues a prescribed command based on the realized sequence to the portable terminal communication part 32 (step 1504). From the portable terminal communication part 32, the necessary URL access instruction is supplied to the portable terminal 16 through the portable terminal I/F 14 (step 1505) and the portable terminal 16 accesses the subject to be monitored (step 1506).

The data transmission from the sequence execution part 170 to the subject to be monitored is similar to the processing in FIG. 4. In this case, the URL of the top page of the site or the like is output and the response from the site as the subject to be monitored is transmitted to the portable terminal 16 (step 1507). The transmitted response is supplied to the service response monitoring processing part 56 and the service performance monitoring processing part 58 (step 1508), and then service response monitoring processing part 56 and the service performance monitoring processing part 58 execute analytical processing for the response (step 1509).

The sequence execution part 170 outputs the next command described in the sequence (step 1510). This is also transmitted to the portable terminal 16 (step 1511) and the portable terminal 16 executes the URL access and so on to the subject to be monitored (step 1512). Hereinafter, the response from the subject to be monitored is transmitted to the processing parts 56, 58 through the portable terminal 16 (step 1513, 1514), and the analytical processing is executed in response thereto (step 1515). The sequence execution part 170 also outputs the next command (step 1516). By repeating such processing, the necessary pages on the site which need to be monitored are accessed, or the server hosting the site is driven by supplying the necessary information.

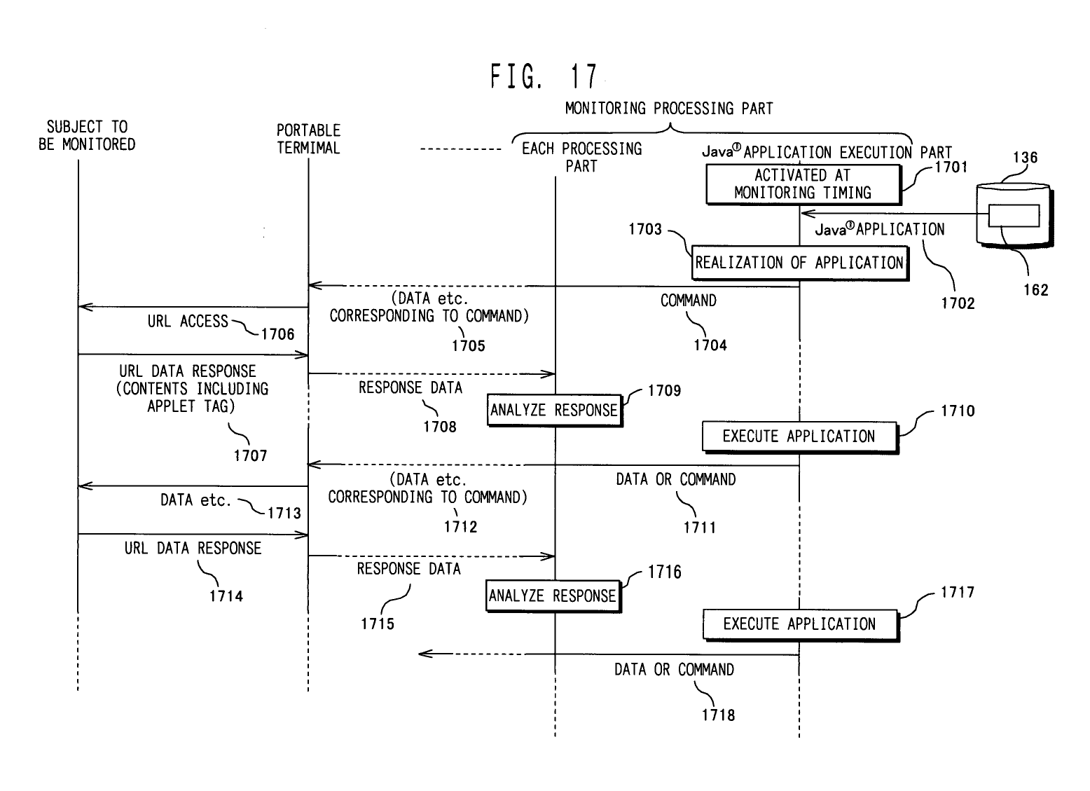

FIG. 16 is a schematic diagram showing an example of the sequence and the access based on this sequence. For instance, assume that the site map shown in FIG. 16 is formed by each page 1601-1605 in the web page group 1600. For such a site, the pages are accessed in the following order;

(i) URL access to the top page 1601,

(ii) input of the user ID (UID) and the password (pwd) to the input column 1611,

(iii) specification of the prescribed menu item (See Numeral 1612) in the main content 1613,

(iv) input of a character string for the content (search page) specified on the menu,

(v) push a button (search activating button) 1614, and

(vi) push the back button 1615 from the search result content 1604.

Accordingly, as shown in FIG. 16B, in order to carry out the above procedures, the sequence 1621 includes commands such as “URL access (Numeral 1620-1)”, “input of UID and pwd (numeral 1620-2)”, “menu (link) specification (numeral 1620-3)”, “input of prescribed character string (numeral 1620-4)”, “prescribed link specification (numeral 1620-5)”, and “prescribed link specification (numeral 1620-6)”.

In this way, it is possible to access the necessary pages by specifying the links and inputting the character strings, and to realize the response and the response performance.

The Java™ applications refer to Java™ applets embedded in the pages delivered from the sites. Concerning the normal accesses using the portable terminal 16, when the applet tag embedded in the web pages is detected, the applet is downloaded to the portable terminal 16. After that, the portable terminal 16 activates the applet and executes the processing, which enables data communication (for instance, necessary data input and content demand) with the site. In the present embodiment, the monitor server 112 stores an application equivalent to the Java™ application corresponding to the downloaded applet in advance, and, when the portable terminal 16 makes an access based on the instruction from the monitor server 112, the monitor server 112 can issue various data and commands just as if the downloaded applet was operating.

FIG. 17 is a flowchart showing another example of processing executed in the monitoring process related to the third embodiment. In the same way as the processing shown in FIG. 15, the URL access activating processing part 54 of the control processing part 134 refers to the monitoring control DB 136 to determine whether it is time to monitor the site. If the monitoring timing for the site in question has arrived, the URL access activating processing part 54 activates the sequence execution part 170 or the Java™ application execution part 172 (step 1701). In this example, the Java TM application execution 172 is activated.

The Java™ application execution part 170 refers to the tables in the monitoring DB 136 to obtain the Java™ application program specified by the pointer. In FIG. 17, the Java™ application specified by the pointer is read out (step 1702), and its detail is realized (step 1703).

As shown in FIG. 14, the URL of the page including the applet tags for downloading the respective Java™ application is described as the header of the Java™ application in the present embodiment (see Numeral 1421). Accordingly, the command for accessing this URL is supplied to the portable terminal communication part 32 from the Java™ application execution part 172 (step 1704). From the portable terminal communication part 32, the necessary URL access instruction is supplied to the portable terminal 16 through the portable terminal I/F 14 (step 1705), and the portable terminal 16 accesses the subject to be monitored (step 1706).

In the site to be monitored, the accessed web page, that is, the web page in which the applet tags are embedded, is transmitted to the portable terminal 16 (step 1707). The response data are supplied to the service response monitoring processing part 56 and the service performance monitoring processing part 58, and analytical processing of the response is executed (step 1709).

The Java™ application execution part 172 executes the Java™ application (step 1710), and transmits the data and commands to be transmitted which are generated as a result of the execution to the portable terminal communication part 32 (step 1711). Such data and commands are also transmitted to the subject to be monitored through the portable terminal 16 and the like (steps 1212, 1213). The response data are received by the processing parts 56, 58 and the analytic processing of the data is executed by them (steps 1715, 1716). Furthermore, the Java™ application execution part 172 executes the Java™ application, and transmits the subsequent data and commands relating to the result of the execution to the portable terminal 16 through the portable terminal communication part 32. By repeating such processing, it is possible to execute the processing and to output the commands and the data which are obtained as a result of the execution to the site side so as to operate the servers hosting the site.

The above-mentioned Java™ applets are used with online games, business sites for banks, stock companies and the like. Any Java™ programs which can be stored in the monitoring control DB 136 are applicable to the present embodiment as long as they correspond to applets.

According to the present embodiment, the sequences including URL, link specification, character string and the like for accessing pages one by one according to the site map and the Java™ applications corresponding to Java (TM) applets downloaded with the applet tags are prepared in advance. As a result, the various instructions are supplied to the portable terminal 16 to cause it to access the site, the responses from the site are analyzed, and the site is monitored as to whether it operates normally.

Therefore, it is possible to access the various pages with the proper route according to the site map and to monitor the sites more appropriately and carefully.

It should be noted that the present invention is in no way limited to the details of the described embodiments and modifications may be made without departing from the scope of the claims, and it is needless to say that such changes may be included within the scope of the present invention.

For instance, in the first and second embodiments, although the access instructions are transmitted from the monitor server 12 to the portable terminal 16 through the portable terminal I/F 14, while on the other hand the data received by the portable terminal 16 are transmitted to the monitor server 12 through the portable terminal 16, the present invention is not limited to this. For example, it is also possible for the monitor server 12 to function as the portable terminal I/F 14 and the portable terminal 16, and to access the sites through the cellular packet network 18 by wireless and the GW 20.

Moreover, in the third embodiment, although a single monitor server accesses the site through a single portable terminal 16, the present invention is not limited to this. Needless to say, it is also possible for the data communication system to have a system of two or more monitor servers and the central monitoring center, as in the second embodiment. In this case, the system of the central monitoring center may store the sequences and the Java™ applications, and supply these to each monitor server as needed to cause them to execute the necessary processing. Further, the monitor servers may store the above-mentioned sequences and Java™ applications.

Furthermore, in the above-mentioned embodiments, although the monitor servers and the like store the Java™ applications corresponding to the Java™ applets, such that the Java TM applets are downloaded with the applet tags, the present invention is not limited to this. The present invention is also applicable to the case where only the application (terminal application) is downloaded by accessing the site with a certain tag (terminal application tag). In this case, the monitor server and the like may store an emulation program equivalent to the above-mentioned terminal application and execute the program.

Still further, it goes without saying that both the sequences and the Java™ applications may be used when the Java™ applet is downloaded at the time of accessing a specific web page in a certain sequence.

In addition, in this description, the function of a single means may be accomplished by two or more physical means and the function of two or more means may be accomplished by a single physical means.

According to the present invention, it is possible to provide a system which can appropriately monitor a site used through Internet connection using portable terminals.

### INDUSTRIAL APPLICABILITY

The present invention can provide a portable terminal and the like with advertisements which suits the user's preferences, and can be used to make banner-type message delivery appropriate. Moreover, it is possible to notify information, substituting for the banner-type message, which suits the user's preferences by causing the information to be contained in content which is a response to a content delivery request from the user's portable terminal.

What is claimed is:

1. (Amended) A method for monitoring sites, which include a first site group connected to the gateway through a private line and a second site group connected to the gateway through Internet, connected through a cellular packet network and a gateway from a portable terminal, the method comprising:
with a monitor server for having the portable terminal to execute an access by use of a prescribed URL through the cellular packet network,
a step for controlling the portable terminal so as to access the site in the first site group by use of the URL at a prescribed timing through a route of the cellular packet network and the gateway;
a step for obtaining response data received by the portable terminal from the site in the first site group through the gateway and the cellular packet network;
a step for detecting whether any abnormality or problem occurs on the site by analyzing the response data; and
a step for generating notification of data for notifying the abnormality or the problem when any abnormality or problem occurs and transmitting the notification data to another system.

2. The method as defined in claim 1, the method further comprising:
a step for examining details of the response data, including an error and the like, and for measuring a response period.

3. The method as defined in claim 1 or claim 2, wherein the step for detecting whether any abnormality or problem occurs further comprises:
a step for calculating a difference between the web content included in the response data in a previous detection step and the web content included in the response data at this time; and
a step for detecting, based on the difference, whether the content has not be subjected to an undesirable modification or whether the content has been appropriately updated.

4. The method as defined in any one of claims 1 to 3, the method further comprising:
a step for storing a sequence including commands to access web pages constituting the site along with a prescribed order according to a site map of the site to be monitored; and wherein
the step for accessing by use of the prescribed URL is accomplished according to the commands in the sequence.

5. (Amended) The method as defined in claim 4, wherein the command includes an alphanumeric string to be inputted in the prescribed web page; and
the method further comprises a step for transmitting data corresponding to the character string to the site through the cellular packet network and the gateway by controlling the portable terminal to input the character string in the prescribed web page.

6. (Amended) A method for monitoring sites connected through a cellular packet network and a gateway from a portable terminal, the method comprising:
with a monitor server for having the portable terminal to execute an access by use of a prescribed URL through the cellular packet network, a step for controlling the portable terminal so as to access the site by use of the URL at a prescribed timing through a route of the cellular packet network and the gateway;
a step for obtaining response data received by the portable terminal from the site through the gateway and the cellular packet network;
a step for detecting whether any abnormality or problem occurs on the site by analyzing the response data;
a step for generating notification data for notifying of the abnormality or the problem when any abnormality or problem occurs and transmitting the notification data to another system;
a step for relating an emulation program, which corresponds to a terminal application to be downloaded with a terminal application specification tag in a web page constituting the site to be monitored, with the URL of the above web page, and storing the emulation program and the URL together with the relationship;
a step for executing the emulation program after accessing by use of the URL stored together with the relationship; and
a step for transmitting data showing a result of the execution of the emulation program to the site through the cellular packet network and the gateway by controlling the portable terminal.

7. The method as defined in claim 6, wherein the step for executing the emulation program includes an input of a prescribed alphanumeric string.

8. (Amended) A method for monitoring sites connected through a cellular packet network and a gateway from portable terminals, the method comprising:
a step for placing a plurality of monitor servers apart from each other to cause the portable terminal to execute an access by use of the prescribed URL through the cellular packet network, the monitor servers being connected to the respective portable terminals;
with one monitor server, a step for controlling the portable terminal so as to access the site by use of the URL at a prescribed timing, through a route of the cellular packet network and the gateway;
a step for obtaining response data received by the portable terminal from the site through the gateway and the cellular packet network;
a step for detecting whether any abnormality or problem occurs on the site by analyzing the response data;
a step for generating notification data for notifying of the abnormality or problem when any abnormality or problem occurs and transmitting the notification data to a central system connected with the monitor server through a network;
with the central system, in response to receipt of the notification data, a step for requesting one or more other monitor servers other than the said monitor server to access the site by use of the URL;
with the other monitor servers, a step for controlling the portable terminal so as to access the site by use of the URL at the prescribed timing through a route of the cellular packet network and the gateway;
a step for obtaining response data received by the portable terminal from the site through the gateway and the cellular packet network;
a step for generating other notification data for notifying of a state of the site by analyzing the response data and transmitting the other notification data to the central system; and
with the central system, a step for analyzing the abnormality and the problem based on the notification data and the other notification data to generate data indicative of an analytical result.

9. The method as defined in claim 8, the method further comprising:
with the central system, a step for specifying a server as a main server which may access the site by use of URL and one or more other servers as reserve servers which may access the site by use of URL when any abnormality or problem occurs with the main server.

10. (Amended) A method for monitoring sites, which include a first site group connected to the gateway through a private line and a second site group connected to the gateway through Internet, connected through a cellular packet network and a gateway from portable terminals, the method comprising:
a step for placing a plurality of monitor servers apart form each other to cause the portable terminal to execute an access by use of a prescribed URL through the cellular packet network, the monitor servers being connected to the respective portable terminals;
with each of the monitor servers, a step for controlling the portable terminal so as to access the site in the first site group by use of the URL at a prescribed timing through a route of the cellular packet network and the gateway;
a step for obtaining response data received by the portable terminal from the site in the first site group through the gateway and the cellular packet network;
a step for generating notification data for notifying of a state of the site by analyzing the response data, and transmitting them to a central system; and
with the central system, a step for generating data indicative of an analytical result about the route for accessing the site and the state of the site based on the notification data.

11. The method as defined any one of claims 8 to 10, the method further comprising:
with the central system, a step for storing a sequence including commands to access web pages constituting the site along with a prescribed order according to a site map of the site to be monitored and
a step for transmitting the sequence including the commands to the monitor servers, and wherein
with the monitor servers, the step for accessing by use of the prescribed URL is executed according to the commands in the sequence.

12. The method as defined in claim 11, wherein the commands include an alphanumeric string to be inputted in the prescribed web page, and
the method further comprises a step for transmitting data corresponding to the character string to the site through the cellular packet network and the gateway by controlling the portable terminal so as to input the character string in the prescribed web page.

13. (Amended) A method for monitoring sites connected through a cellular packet network and a gateway from a portable terminal, the method comprising:
with a monitor server for having the portable terminal to execute an access by use of a prescribed URL through the cellular packet network,
a step for controlling the portable terminal so as to access the site by use of the URL at a prescribed timing through a route of the cellular packet network and the gateway;
a step for obtaining response data received by the portable terminal from the site through the gateway and the cellular packet network;
a step for detecting whether any abnormality or problem occurs on the site by analyzing the response data;
a step for generating notification data for notifying of the abnormality or the problem when any abnormality or problem occurs and transmitting the notification data to another system;
with the central system, a step for relating an emulation program, which corresponds to a terminal application to be downloaded with a terminal application specification tag in the web pages constituting the site to be monitored, with the URL of the above web page and storing the emulation program and the URL;
a step for transmitting the emulation program and the URL of the web page to the monitor servers;
a step for executing the emulation program after accessing by use of the URL stored together with the relationship; and
a step for transmitting data showing a result of execution of the emulation program to the site through the cellular packet network and the gateway by controlling the portable terminal.

14. The method as defined in claim 13, wherein the step for executing the emulation program includes input of a prescribed alphanumeric string.

15. The method as defined in any one of claims 8 to 10, the method further comprising, in the monitor server, a step for storing a sequence including commands to access web pages constituting the site along with a prescribed order according to a site map of the site to be monitored; and wherein
in the monitor server, the step for accessing by use of the URL is accomplished according to the commands in the sequence.

16. The method as defined in claim 15, wherein the command includes an alphanumeric string to be inputted in the prescribed web page, and
the method further comprises a step for transmitting data corresponding to the character string to the site through the cellular packet network and the gateway by controlling the portable terminal to input the character string in the prescribed web page.

17. (Amended) A method for monitoring sites connected through a cellular packet network and a gateway from portable terminals, the method comprising:
a step for placing a plurality of monitor servers apart form each other to cause the portable terminal to execute an access by use of a prescribed URL through the cellular packet network, the monitor servers being connected to the respective portable terminals;
with one monitor server, a step for controlling the portable terminal so as to access the site by use of the URL at a prescribed timing, through a route of the cellular packet network and the gateway;
a step for obtaining response data received by the portable terminal from the site through the gateway and the cellular packet network;
a step for detecting whether any abnormality or problem occurs on the site by analyzing the response data;
a step for generating notification data for notifying of the abnormality or the problem when any abnormality or problem occurs and transmitting the notification data to a central system connected with the monitor server through a network;
with the central system, in response to receipt of the notification data, a step for requesting one or more other monitor servers other than the said monitor server to access the site by use of the URL;
with the other monitor servers, a step for controlling the portable terminal so as to access the site by use of the URL at the prescribed timing through a route of the cellular packet network and the gateway;
a step for obtaining response data received by the portable terminal from the site through the gateway and the cellular packet network;
a step for generating other notification data for notifying of a state of the site by analyzing the response data and transmitting the other notification data to the central system;
with the central system, a step for analyzing the abnormality and the problem based on the notification data and the other notification data to generate data indicative of an analytical result;
with the monitor server, a step for relating an emulation program, which corresponds to a terminal application to be downloaded with a terminal application specification tag in the web page constituting the site to be monitored, with the URL of the above web page and storing the emulation program and the URL together with the relationship;
a step for executing the emulation program after accessing by use of the URL stored with the relationship; and
a step for transmitting data showing a result of execution of the emulation program to the site through the cellular packet network and the gateway by controlling the portable terminal.

18. The method as defined in claim 17, wherein the step for executing the emulation program includes an input of a prescribed alphanumeric string.

19. (Amended) A system for monitoring sites, which include a first site group connected to the gateway through a private line and a second site group connected to the gateway through Internet, connected through a cellular packet network and a gateway from a portable terminal, the system comprising:
a portable terminal control means for controlling the portable terminal so as to access the site in the first site group by use of an URL at a prescribed timing through a route of the cellular packet network and the gateway;
a response data analysis means for obtaining response data received by the portable terminal from the site in the first site group through the gateway and the cellular packet network and for determining whether any abnormality or problem occurs on the site by analyzing the response data; and
a data communication means for generating notification data for notifying of the abnormality or the problem when any abnormality or problem occurs and for transmitting the notification data to another system.

20. The system as defined in claim 19, wherein the response data analysis means examines details of the response data including an error and the like and measures a response period.

21. The system as defined in claim 19 or 20, wherein the response data analysis means calculates a difference between the web content included in the response data in a previous step for determining and the web content included in the response data at this time, and determines, based on the difference, whether the content has not be modified or whether the content has been appropriately updated.

22. (Amended) A system for monitoring sites connected through a cellular packet network and a gateway from a portable terminal, the system comprising:
a portable terminal control means for controlling the portable terminal so as to access the site by use of an URL at a prescribed timing through a route of the cellular packet network and the gateway;
a response data analysis means for obtaining response data received by the portable terminal from the site through the gateway and the cellular packet network and for determining whether any abnormality or problem occurs on the site by analyzing the response data; and
a storing means for storing a sequence, including commands to access the web pages constituting the site along with a prescribed order according to a site map of the site to be monitored, and/or an emulation program corresponding to a terminal application to be downloaded with a terminal application specification tag in the web page constituting the site together with the relationship thereof with the URL of the above web page, and wherein
the portable terminal control means controls the portable terminal such that the URL access according to the commands in the sequence is executed, and/or when the URL access which is related to the emulation program is executed the portable terminal executes the emulation program, so as to transmit data indicative of the result of the execution to the site.

23. The system as defined in claim 22, wherein the command includes an alphanumeric string to be inputted in the prescribed web page, and
the portable terminal control means controls the portable terminal to input the alphanumeric string in the prescribed web page.

24. The system as defined in claim 22 or 23, wherein the portable terminal control means executes the emulation program accompanying the input of the prescribed alphanumeric string.

25. (Amended) A system for monitoring sites connected through a cellular packet network and a gateway from portable terminals, the system comprising:
a plurality of monitor servers to cause the portable terminal to execute an access by use of a prescribed URL through the cellular packet network, the monitor servers being placed apart from each other and connected to the respected portable terminals; and
a central monitoring center system connected to the monitor servers through a network;
each of the monitor servers comprising;
a portable terminal control means for controlling the portable terminal so as to access the site by use of the URL at a prescribed timing through a route of the cellular packet network and the gateway;
a response data analysis means for obtaining response data received by the portable terminal from the site through the gateway and the cellular packet network and for generating analytical data including the notification data indicative of occurrence of any abnormality or problem on the site by analyzing the response data;
a data communication means for transmitting the notification data to the central monitoring center system, and
the central monitoring center system comprising;
a monitor server administration means for administering the monitor servers such that the monitor server administration means requests the prescribed monitor server to monitor one site as a main server and requests one or more monitor servers among the other monitor servers to monitor as reserve servers; and
an abnormality analysis means for analyzing the abnormality or the problem based on the notification data from the main server and the analytical data from the reserve servers and for generating data indicative of an analytical result.

26. (Amended) A system for monitoring sites, which include a first site group connected to the gateway through a private line and a second site group connected to the gateway through Internet, connected through a cellular packet network and a gateway from a portable terminal, the system comprising:
a plurality of monitor servers to cause the portable terminal to execute an access by use of a prescribed URL through the cellular packet network; and
a central monitoring center system connected to the monitor servers through a network;
each of the monitor servers comprising;
a portable terminal control means for controlling the portable terminal so as to access the site by use of the URL at a prescribed timing through a route of the cellular packet network and the gateway;
a response data analysis means for obtaining the response data received by the portable terminal from the site through the gateway and the cellular packet network and for generating analytical data including notification data indicative of occurrence of any abnormality or problem on site by analyzing the response data; and
a data communication means for transmitting the notification data to the central system; and
the central monitoring center system comprising;
a monitor server administration means for administering the monitor servers to request the prescribed monitor servers among the monitor servers to monitor one site in the first site group; and
a route/site situation analysis means for receiving the analytical data about the one site in the first site group obtained by each of the monitor servers and for generating data indicative of an analytical result about the route for accessing the site in the first site group and a situation of the site in the first site group.

27. The system as defined in claim 25 or 26, wherein,
the central system further comprises a storing means for storing a sequence, including commands to access the web pages constituting the site along with a prescribed order according to a site map of the site to be monitored, and/or an emulation program corresponding to a terminal application to be downloaded with a terminal application specification tag in the web page constituting the site together with the relationship thereof with the URL of the above web page, and
the central system transmits the relationship of the sequence and/or the emulation program with the URL to the monitor server, and
the portable terminal control means controls the portable terminal such that the URL access according to the commands in the sequence is executed, and/or when the URL access which is related to the emulation program is executed the portable terminal executes the emulation program, so as to transmit data indicative of the result of the execution to the site.

28. The system as defined in claim 25 or 26, wherein,
the monitor server further comprises a storing means for storing a sequence, including commands to access the web pages constituting the site along with a prescribed order according to a site map of the site to be monitored, and/or an emulation program corresponding to a terminal application to be downloaded with a terminal application specification tag in the web page constituting the site together with the relationship thereof with the URL of the above web page, and
the portable terminal control means controls the portable terminal such that the URL access according to the commands in the sequence is executed, and/or when the URL access which is related to the emulation program is executed the portable terminal executes the emulation program, so as to transmit data indicative of the result of the execution to the site.
